(19) United States
(12) Patent Application Publication
(10) Pub. No.: US 2023/0363563 A1
(43) Pub. Date: Nov. 16, 2023

(54) SYSTEM AND METHOD FOR CREATING AN ILLUSION OF VARIOUS MYTHICAL CREATURES

(71) Applicant: Kody Evans, Woodinville, WA (US)

(72) Inventor: Kody Evans, Woodinville, WA (US)

(21) Appl. No.: 17/741,908

(22) Filed: May 11, 2022

(51) Int. Cl. A47G 33/00; A63H 33/22; C09D 11/50

(52) U.S. Cl. CPC A47G 33/00; A63H 33/22; C09D 11/50

(57) ABSTRACT

Embodiments are provided for a series of holiday themed kits for tracking a visit by a mystical figure such as Santa Claus, the Easter Bunny, Leprechaun, Elves, or the Tooth Fairy whereby the kit includes devices for making footprints or tracks with an ink or paint that glows with an ultraviolet light and includes other accessories such as a magnifying glass to track footprints or fingerprints left by a mystical figure as well as other accessories that would create the illusion of a visit of a mythical creature.

### FIELD OF THE DISCLOSURE

This disclosure relates generally to the field of theatrical or play acting props and more specifically relates to a kit including items for use by parents or others to simulate a visit by various mythical creatures for the enjoyment of children.

### BACKGROUND

Stories of mythical creatures such as the Tooth Fairy and Santa Claus are very well known and enjoyed around the world. For instance, the folklore states that when children lose one of their baby teeth, they should place it underneath their pillow or on their bedside table and the Tooth Fairy will visit while they sleep, replacing the lost tooth with a small payment. Typically, this is done by the parents who pretend to be the tooth fairy. Various types of kits and items have been manufactured for creating an illusion of these mythical creatures. However, these kits are either too complicated or do not take into account the fact that children can have relatively short attention spans, and in consequence the items in these kits are likely to hold the interest of a child for only a short period of time. Thus exists the need for an improved system and method for a kit for creating the illusion of mythical creatures.

### SUMMARY

The disclosure presented herein relates to exemplary embodiments for a kit for creating the illusion of mythical creatures. Each kit has a stepped process that involves using a UV reactive fluid, to set a trap, so that the mythical creature/figure will touch the fluid, and leave behind tracks/prints, an ultraviolet light or blacklight, and a glowing paint or powder. There is a kit for creating the illusion of the Tooth Fairy with a vinyl wall decal glowing door, glowing paint, and blacklight. There is a kit for creating the illusion of Santa Claus with edible glowing paint that is squirted on Santa’s cookies. There is a kit for creating the illusion of the Easter Bunny with glowing paint that goes on and inside of an Easter egg. There is a kit for creating the illusion of leprechauns with glowing paint that goes into a small cauldron. There is a kit for creating the illusion of an elf with glowing paint to be left in a puddle near the elf.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure. Also, the drawings included herein are considered by the applicant to be informal.

FIGS. 1A-1B are a perspective view of one embodiment of a Tooth Fairy kit.

FIG. 2 is a perspective view of one embodiment of an Easter Bunny kit.

FIG. 3 is a perspective view of one embodiment of a Leprechaun kit.

FIGS. 4A-4B is a perspective view of one embodiment of an elf kit.

FIGS. 5A-5B is a perspective view of one embodiment of a Santa Claus kit.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number) - (a second number),” this means a range whose limit is the second number. For example, 25 to 100 mm means a range whose lower limit is 25 mm and upper limit is 100 mm.

The present invention is directed to a series of kits for tracking a visit by a mystical figure such as Santa Claus, the Easter Bunny, Leprechaun, Elves, or the Tooth Fairy. The kit includes devices for making footprints or tracks with an ink or paint that is glows under an ultraviolet light or blacklight. The kit includes other accessories such as a magnifying glass to track footprints or fingerprints left by a mystical figure as well as other accessories that would create the illusion of a visit of a mythical creature. Stamps may also include a variety of stickers and tattoos to be more festive.

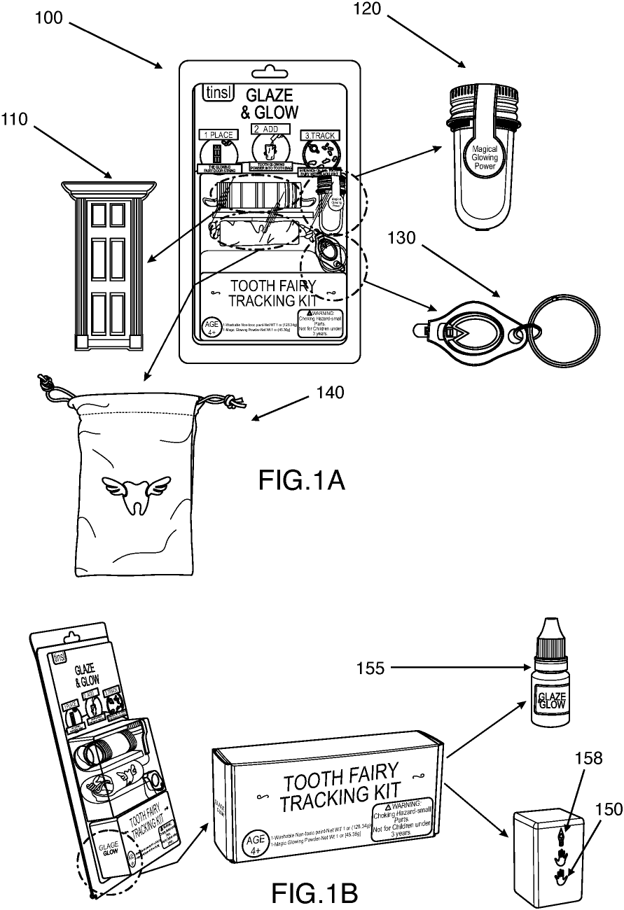

FIGS. 1 shows a perspective view of an exemplary embodiment of a tooth fairy kit 100 that includes a fairy door 110, magical glowing fairy dust 120, an ultraviolet light 130, a tooth bag 140 that are given or revealed to the child, and stamps 150 along with stamp ink 155 and a stamp pad 158 that are concealed from the child in a “parents only” box to help with the illusion. Kit 100 may come with a Fairy dust 120 may be made of an ultra violet powder. Stamp ink 155 may be washable, ultraviolet, and non-toxic, which is designed to be wiped from non-porous surfaces with just the wipe of a wet cloth. Stamps 150 are provided solely for purposes of illustration and that a variety of different styles of feature stamps having different images thereon may be utilized in combination with the present invention without departing from the spirit and scope of the present invention.

Stamps 150 may have a handle secured to a flange. The flange defines a feature surface upon which a raised image is formed. The raised images may be a left hand of the fairy, a right hand of the fairy, a left foot of the fairy, or a right foot of the fairy. The raised image may be carved, molded, laser engraved or vulcanized onto the feature surface. However, this is non-limiting and may be of any design pertaining to body parts of a fairy. Fairy door 110 may be a reusable sticker with repositionable glue on the bottom of the sticker. Stamp pad 158 may have a raised surface for inking stamps 150 and is a durable foam pad for transferring an amount of ink. Stamp ink 155 may be poured on stamp pad 158 or stamp pad 158 may have pre pre-saturated with the ultraviolet ink. Ultraviolet light 130 may include one or more ultraviolet disposed in the housing. Ultraviolet light 130 may have one or more actuators on the housing for activating the ultraviolet LEDs. Ultraviolet light 130 may be connected to a keychain or other apparatus. Ultraviolet light 130 may have an attachable magnifying glass to provide closer examination.

When in use the children would peel and place the removable and reusable glowing tooth fairy door 110. Children would then add magical glowing fairy dust 120 and the lost tooth to tooth bag 140 whereby the story interaction would be that when the tooth fairy goes to swap out the tooth, she will get covered in the glowing dust and everything she touches will glow. The stamps 150 may then be pressed by parents onto any type of medium such that the colored image of the fairy is transferred to the medium. The medium used may be wood, metal, glass, plastic, plaster, drywall, or rock. The children would then track the glowing prints left behind with ultraviolet light 130 which may illuminate the created prints.

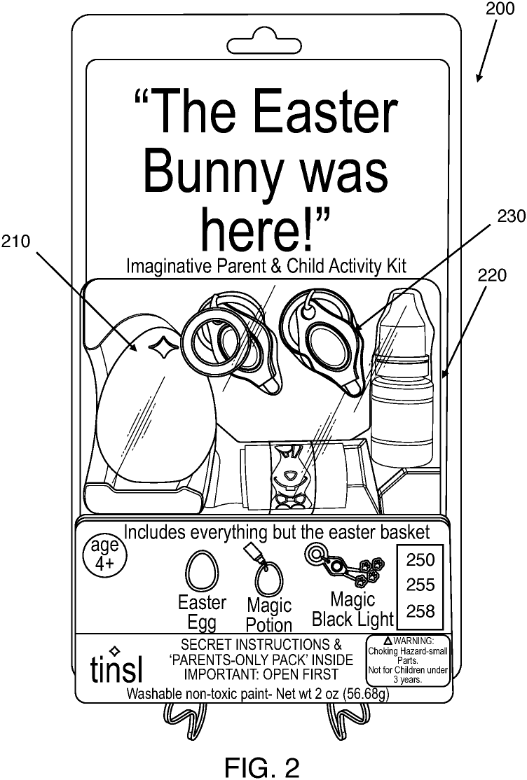

FIG. 2 shows a perspective view of an exemplary embodiment of an easter kit 200 that includes easter eggs 210, magical glowing paint 220, and an ultraviolet light 230 that are given or revealed to the child, and stamps 250 along with stamp ink 255 and a stamp pad 258 that are concealed from the child to help assist in the illusion. Kit 200 may come with a glowing paint 220 which may be made of an ultra violet paint. Stamp ink 255 may be washable, ultraviolet, and non-toxic, which is designed to be wiped from non-porous surfaces with just the wipe of a wet cloth. Stamps 250 are provided solely for purposes of illustration and that a variety of different styles of feature stamps having different images thereon may be utilized in combination with the present invention without departing from the spirit and scope of the present invention.

Stamps 250 may have a handle secured to a flange. The flange defines a feature surface upon which a raised image is formed. The raised images may be a left foot of the Easter Bunny or a right foot of the Easter Bunny. The raised image may be carved, molded, laser engraved or vulcanized onto the feature surface. However, this is non-limiting and may be of any design pertaining to body parts of the Easter Bunny. Stamp pad 258 may have a raised surface for inking stamps 250 and is a durable foam pad for transferring an amount of ink. Stamp ink 255 may be poured on stamp pad 258 or stamp pad 258 may have pre pre-saturated with the ultraviolet ink. Ultraviolet light 230 may include one or more ultraviolet disposed in the housing. Ultraviolet light 230 may have one or more actuators on the housing for activating the ultraviolet LEDs. Ultraviolet light 230 may be connected to a keychain or other apparatus.

When in use, the children may place glowing paint 220 on easter eggs 210 whereby the story interaction would be that when the Easter Bunny will hide the easter eggs. The parents would then press stamps 250 onto any type of medium such that the colored image of the Easter Bunny is transferred to the medium. The medium used may be wood, metal, glass, plastic, plaster, drywall, or rock. The child would then track the glowing prints left behind with ultraviolet light 230 which may illuminate the created prints.

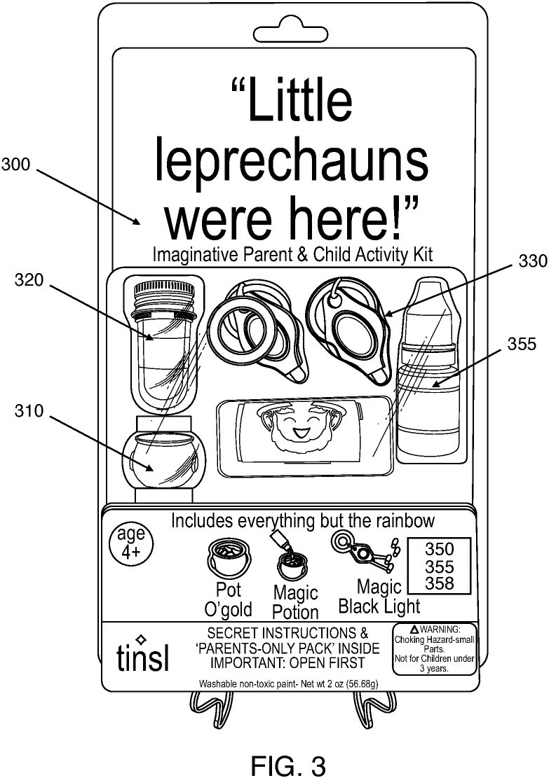

FIG. 3 shows a perspective view of an exemplary embodiment of a leprechaun kit 300 that includes a small plastic cauldron 310, flakes 320, and ultraviolet light 330 that are revealed to the child and stamps 350 along with two bottles of stamp ink 355 and a stamp pad 358 that are concealed from the child by the parents to help with the illusion. Stamp ink 355 may be washable, ultraviolet, and non-toxic, which is designed to be wiped from non-porous surfaces with just the wipe of a wet cloth. Stamps 350 are provided solely for purposes of illustration and that a variety of different styles of feature stamps having different images thereon may be utilized in combination with the present invention without departing from the spirit and scope of the present invention.

Stamps 350 may have a handle secured to a flange. The flange defines a feature surface upon which a raised image is formed. The raised images may be a left foot of the leprechaun or a right foot of the leprechaun or a four leaf clover. The raised image may be carved, molded, laser engraved or vulcanized onto the feature surface. However, this is non-limiting and may be of any design pertaining to other components associated with a leprechaun. Stamp pad 358 may have a raised surface for inking stamps 350 and is a durable foam pad for transferring an amount of ink. Stamp ink 355 may be poured on stamp pad 358 or stamp pad 358 may have pre pre-saturated with the ultraviolet ink. Ultraviolet light 330 may include one or more ultraviolet disposed in the housing. Ultraviolet light 330 may have one or more actuators on the housing for activating the ultraviolet LEDs. Ultraviolet light 330 may be connected to a keychain or other apparatus.

When in use, the children place flakes 320 in cauldron 310 whereby the story interaction would be that the leprechaun would come and take some golden flakes from cauldron 310.. The parents may then press stamps 350 onto any type of medium such that the colored image of the leprechaun is transferred to the medium. The medium used may be wood, metal, glass, plastic, plaster, drywall, or rock. The children would then track the glowing prints left behind with ultraviolet light 230 which may illuminate the created prints.

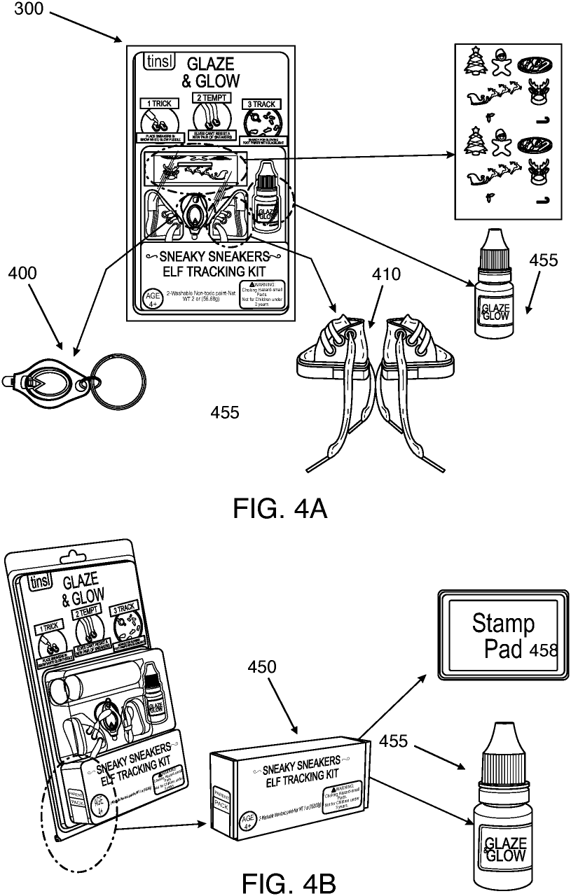

FIGS. 4 shows a perspective view of an exemplary embodiment of an elf kit 400 that includes a small set of shoes 410, a first bottle of stamp ink 455, and an ultraviolet light 430 that are given or revealed to the child, along with stamps 450, a second bottle stamp ink 455, and a stamp pad 358 that are concealed from the child to assist in the illusion. Stamp ink 455 may be washable, ultraviolet, and non-toxic, which is designed to be wiped from non-porous surfaces with just the wipe of a wet cloth. Stamp pad 458 may have a raised surface for inking shoes 410 and is a durable foam pad for transferring an amount of ink. Stamp ink 455 may be poured on stamp pad 458 or stamp pad 458 may have pre saturated with the ultraviolet ink. Ultraviolet light 430 may include one or more ultraviolet disposed in the housing. Ultraviolet light 430 may have one or more actuators on the housing for activating the ultraviolet LEDs. Ultraviolet light 430 may be connected to a keychain or other apparatus.

Stamps 450 may have a handle secured to a flange. The flange defines a feature surface upon which a raised image is formed. The raised images may be similar to shoes 410. The raised image may be carved, molded, laser engraved or vulcanized onto the feature surface. However, this is non-limiting and may be of any design pertaining to other components associated with a leprechaun. Stamp pad 358 may have a raised surface for inking stamps 350 and is a durable foam pad for transferring an amount of ink. Stamp ink 355 may be poured on stamp pad 358 or stamp pad 358 may have pre pre-saturated with the ultraviolet ink. Ultraviolet light 330 may include one or more ultraviolet disposed in the housing. Ultraviolet light 330 may have one or more actuators on the housing for activating the ultraviolet LEDs. Ultraviolet light 330 may be connected to a keychain or other apparatus.

When in use, the children would place shoes 410 on a surface whereby the story interaction would be that the elf cannot resist a pair of shoes. The shoes 410 or stamps 450 may also be pressed onto any type of medium such that the colored image of the leprechaun is transferred to the medium. The medium used may be wood, metal, glass, plastic, plaster, drywall, or rock. The child would then track the glowing prints left behind with ultraviolet light 230 which may illuminate the created prints.

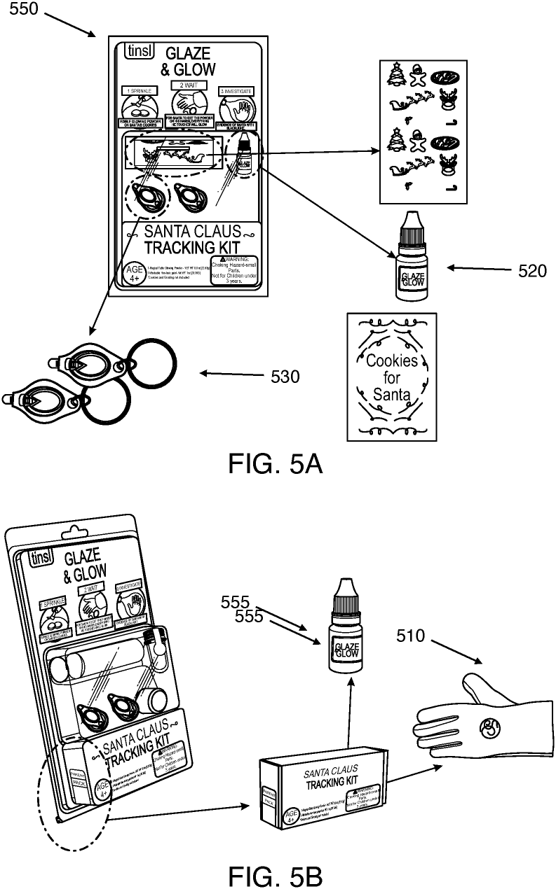

FIGS. 5 shows a perspective view of an exemplary embodiment of a Santa Claus kit 500 that includes edible magical glowing paint 520 and ultraviolet light 530 that are given or revealed to the child and a Santa glove 510 and paint 555 concealed from the child to help with the illusion. Paint 555 may be washable, ultraviolet, and non-toxic, which is designed to be wiped from non-porous surfaces with just the wipe of a wet cloth.. Ultraviolet light 530 may include one or more ultraviolet disposed in the housing. Ultraviolet light 530 may have one or more actuators on the housing for activating the ultraviolet LEDs. Ultraviolet light 530 may be connected to a keychain or other apparatus.

When in use, the children place magical paint 520 on one or more cookies with the story interaction that Santa would get residue from the magical paint 520 when trying to eat cookies. Paint 555 would then be placed by the parents on Santa glove 510 and then marked on various surfaces. The children would then track the glowing prints left behind with ultraviolet light 530 which may illuminate the created prints

While preferred and alternate embodiments have been illustrated and described, as noted above, many changes can be made without departing from the spirit and scope of the invention. Accordingly, the scope of the invention is not limited by the disclosure of these preferred and alternate embodiments. Instead, the scope of the invention is determined entirely by reference to the claims. Insofar as the description above and the accompanying drawings (if any) disclose any additional subject matter that is not within the scope of the claims below, the inventions are not dedicated to the public and Applicant hereby reserves the right to file one or more applications to claim such additional inventions.

The reader’s attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. §112 ¶ 6. In particular, the use of “step of” in the claims herein is not intended to invoke the provisions of U.S.C. §112 ¶ 6.

I claim:

1. A kit for creating an illusion that suggests a visit from mythical creature at a premises, said kit comprising: a) items revealed to a child audience, the items revealed to the child audience comprising an ultraviolet light and b) items at least temporarily concealed from the child audience, the items at least temporarily concealed from the child audience comprising one or more apparatuses for making marks to mark an illusionary trail of the mythical creature in said premises.

2. The kit as claimed in claim 1 wherein the items revealed to the child audience further comprises one or more eggs and glowing paint that is positionable onto the one or more eggs.

3. The kit as claimed in claim 2 wherein the items at least temporarily concealed from the child audience are one or more stamps with a design for a left foot or right foot of an easter bunny and ultraviolet ink of paint to dye the stamp that is traceable by the ultraviolet light.

4. The kit as claimed in claim 1 wherein the items revealed to the child audience further comprises a cauldron and golden flakes placeable into the cauldron.

5. The kit as claimed in claim 4 wherein the items at least temporarily concealed from the child audience are one or more stamps with a design for a left foot or right foot of a leprechaun and ultraviolet ink of paint to dye the stamp that is traceable by the ultraviolet light.

6. The kit as claimed in claim 1 wherein the items revealed to the child audience further comprises a tooth fairy bag, a fairy door that is attachable to a surface, and fairy dust.

7. The kit as claimed in claim 6 wherein the items at least temporarily concealed from the child audience are one or more stamps with a design for a left hand of a tooth fairy, a right hand of the tooth fairy, a left foot of the tooth fairy, or a right foot of a tooth fairy and ultraviolet ink of paint to dye the stamp that is traceable by the ultraviolet light.

8. The kit as claimed in claim 1 wherein the items revealed to the child audience further comprises elf shoes.

9. The kit as claimed in claim 8 wherein the items at least temporarily concealed from the child audience are ultraviolet ink of paint to dye the elf shoes that is traceable by the ultraviolet light.

10. The kit as claimed in claim 8 wherein the items at least temporarily concealed from the child audience are ultraviolet ink of paint to dye a stamp with a design of a sole of the elf shoes that is traceable by the ultraviolet light.

11. The kit as claimed in claim 1 wherein the items revealed to the child audience further comprises edible paint be placed on cookies.

12. The kit as claimed in claim 11 wherein the items at least temporarily concealed from the child audience are a Santa glove and ultraviolet ink or paint to be placed on the Santa glove then onto a surface that is traceable by the ultraviolet light.

13. A method for creating an illusion that suggests a visit from a mythical creature in a premises, the method comprising:
providing items revealed to a child audience, the items revealed to the child audience comprising an ultraviolet light; and
providing items at least temporarily concealed from the child audience, said concealed items comprising means for making marks to mark an illusionary trail of the mythical creature in said premises.

14. The method of claim 13 further comprising: providing one or more eggs and glowing paint that is positionable onto the one or more eggs.

15. The method of claim 14 further comprising: providing one or more stamps with a design for a left foot or right foot of an easter bunny and ultraviolet ink of paint to dye the stamp that is traceable by the ultraviolet light.

16. The method of claim 13 further comprising: providing a tooth fairy bag, a fairy door that is attachable to a surface, and fairy dust.

17. The method of claim 16 further comprising: providing one or more stamps with a design for a left hand of a tooth fairy, a right hand of the tooth fairy, a left foot of the tooth fairy, or a right foot of a tooth fairy and ultraviolet ink of paint to dye the stamp that is traceable by the ultraviolet light.

18. The method of claim 13 further comprising: providing elf shoes and ultraviolet ink that is traceable by the ultraviolet light.

19. The method of claim 13 further comprising: providing edible paint to be placed on cookies, a Santa glove and ultraviolet ink or paint to be placed on the Santa glove then onto a surface that is traceable by the ultraviolet light.

20. The method of claim 13 further comprising: providing a cauldron and golden flakes that are placeable into the cauldron and one or more stamps with a design for a left foot or right foot of a leprechaun and ultraviolet ink of paint to dye the stamp that is traceable by the ultraviolet light.
